(19) United States
(12) Patent Application Publication
(10) Pub. No.: US 2015/0338194 A1
(43) Pub. Date: Nov. 26, 2015

(54) Fixed Blade Spray Knife

(71) Applicant: Michael Flynn, Newport Beach, CA (US)

(72) Inventor: Michael Flynn, Newport Beach, CA (US)

(21) Appl. No.: 14/284,399

(22) Filed: May 22, 2014

(51) Int. Cl. F41H 9/10; B26B 11/00

(52) U.S. Cl. CPC F41H 9/10; B26B 11/00

(57) ABSTRACT

A dual function self-defense device is provided that includes a fixed blade knife and a chemical agent spray device that can be interchangeably and readily used. The spray device has a pressurized canister portion that contains chemical agents and a head portion that includes a spray activation button and a spray nozzle for expelling the chemical agents. The self-defense device has a hollow handle having a hatch for accessing a handle chamber configured to receive the spray device and house the pressurized canister portion of the spray device. A chamber affixed to a top side of the handle is configured to house the head portion of the spray device and has an opening for access thereto. A knife blade is affixed to a top surface of the spray head-containing chamber.

### RELATED U.S. APPLICATION DATA

This application claims priority to Provisional Application No. 61/832,902, filed Jun. 9, 2013.

### FIELD OF THE INVENTION

The present invention relates to self-defense and combat devices.

### BACKGROUND OF THE INVENTION

Personal defense devices are important and ubiquitous in both civilian and combat settings. Personal defense devices such tasers, pepper spray, mace and knives are commonly used for personal safety by civilians, police and military. There is always a need and advantage to designed self defense devices with improved characteristics such as size, weight, and effectiveness. It is particularly advantageous to have a self device that provides more than one mode of defense to increase effectiveness and eliminate the need for carrying multiple devices. It is further desirable to have a dual function device that is convenient and does not add considerable increases in size or weight.

### SUMMARY OF THE INVENTION

A dual function self-defense device is provided that includes a fixed blade knife and a chemical agent spray device that can be interchangeably and readily used. The spray device has a pressurized canister portion that contains chemical agents and a head portion that includes a spray activation button and a spray nozzle for expelling the chemical agents. The self-defense device has a hollow handle having a hatch for accessing a handle chamber configured to receive the spray device and house the pressurized canister portion of the spray device. A chamber affixed to a top side of the handle is configured to house the head portion of the spray device and has an opening for access thereto. A knife blade is affixed to a top surface of the spray head-containing chamber.

### BRIEF DESCRIPTION OF THE DRAWINGS

FIG. 1 illustrates a perspective view of the back side of the dual function self-defense device of the present invention, showing the handle, top portion of the spray device within the handle's open top chamber, and knife blade.

FIG. 2 illustrates a side view of the dual function self-defense device of the present invention.

FIG. 3 illustrates a perspective view of the front side of the dual function self-defense device of the present invention, showing the grip portion of the handle, and activated spray device expelling its contents in a direction away from the knife.

FIG. 4 illustrates an isometric view of the back side of the dual function self-defense device of the present invention, wherein the canister replacement hatch has been removed, exposing the interior chamber to facilitate spray device replacement.

### DETAILED DESCRIPTION

The present invention provides a consolidated self-defense device that is advantageously suited for use in police and military/combat settings, as well as personal or home defense. The device combines a knife component with a repellant spray component. The repellant spray may be a pepper spray, mace, or other suitable repellent compound held in a repellant container or canister. The repellant spray is generally intended to be the user's first line of defense, due to its larger range, while the knife provides a second line of defense as it requires a closer range of use.

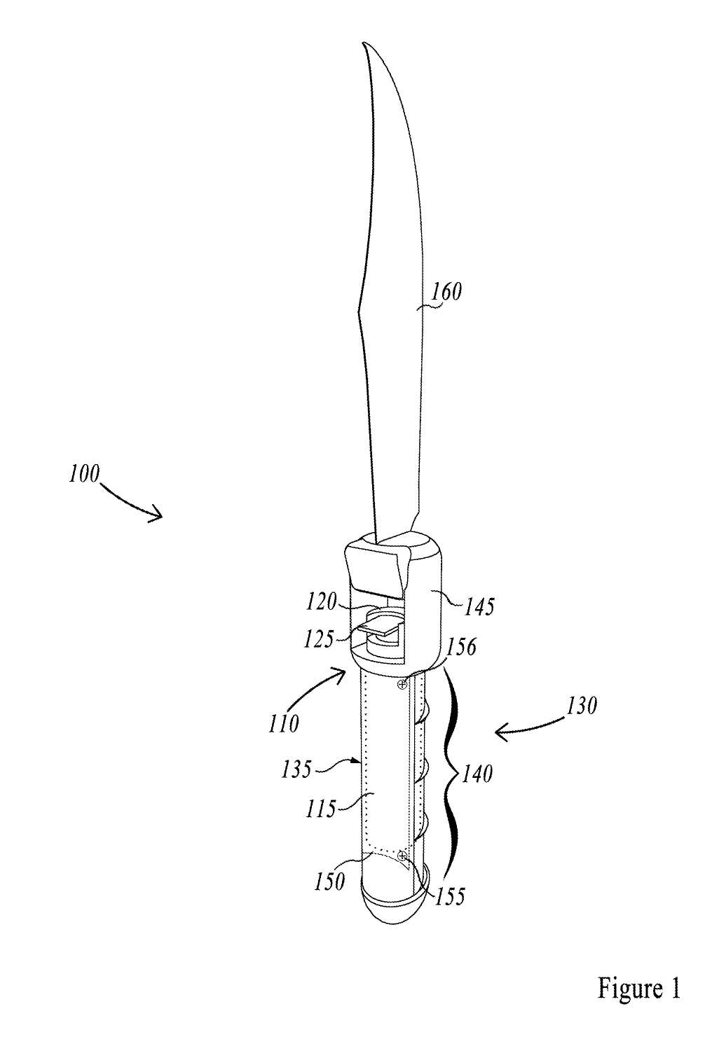

FIG. 1 illustrates a perspective view of the back side of the dual function self-defense device. The device 100 comprises a knife blade 160 and a hollow-chambered handle 130 which houses an appropriate spray device 110 of the user's choosing. The spray device further comprises a pressurized canister 115 which lies within the handle chamber 135, and a spray head 120 which includes a spray activator button 125. During regular usage, the spray head is the only portion of the spray device that visibly protrudes from the lower handle chamber, while the canister portion is obscured within the handle chamber 135. The handle 130 further comprises an open top chamber 145. A front side of the handle 130 includes a grip portion 140, corresponding to the sharp (front) side of the knife blade 160. Additionally, the handle possesses a canister replacement hatch 150 on the back side of the handle 130 corresponding to the back of the knife blade 160. The canister replacement hatch 150 is attached to the handle via a plurality of screws or other attachment means as known in the art, with two of such screws 155 and 156 shown in the view of FIG. 1.

The spray head 120 (including the spray activator button 125) lies within the open chamber 145. The open chamber 145 is configured to allow the user to safely place their finger into the chamber in order to operate the spray device. Because the blade is above the open top chamber and the spray controls, the use of the knife does not interfere with the spray controls. Indeed, the user could use the knife as well as the spray without reconfiguring their fingers or hand position on the handle 130. The open chamber 145 protects the spray activator button 125 and the user's finger during use. Thus, the spray device can be operated safely without interference from, or contact with, the knife blade 160.

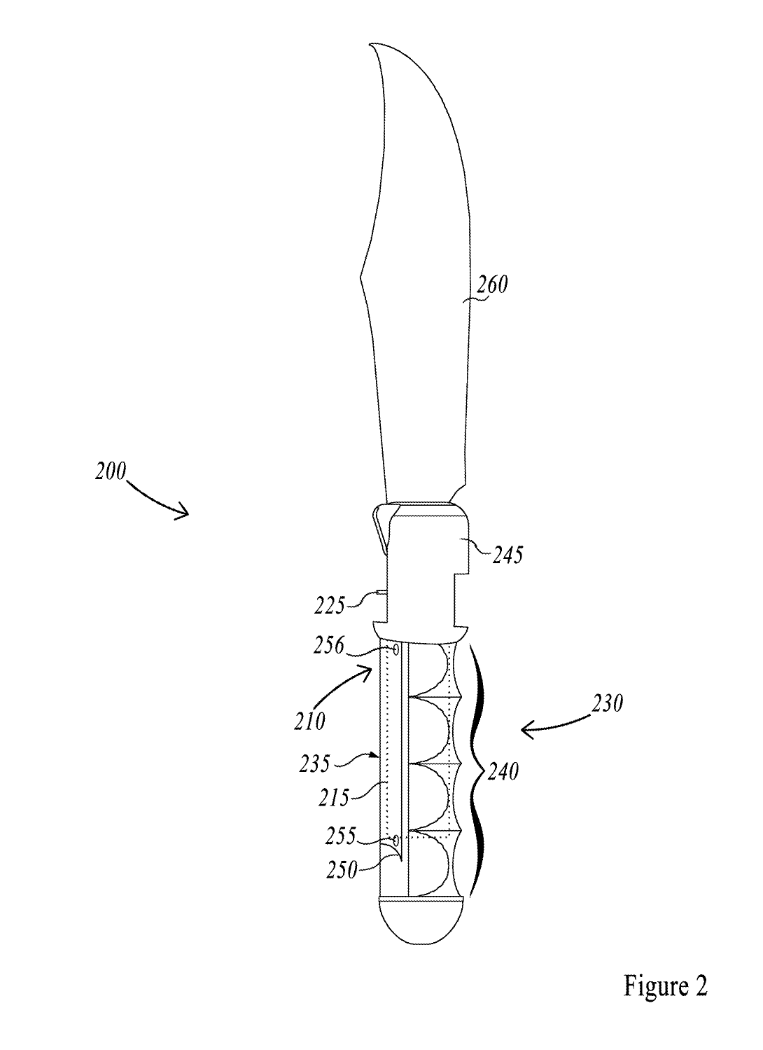

FIG. 2 illustrates a side view of the self-defense device of the present invention. The device effectively enhances and diversifies user capability in a defense situation, while maintaining the usability of a typical knife. The outer surface of the handle 230 may be cylindrical or have a contoured shape for a better grip as shown in FIG. 2. Although FIG. 2 illustrates a specific style of handle grip 240, a variety of grips may be utilized while maintaining adequate space within the handle to receive and replace a spray device 210. FIG. 2 shows how the pressurized canister 215 lies entirely within the lower handle chamber 235, its vertical axis nearly aligned with the vertical axis of the self-defense device 200. In an exemplary embodiment, the grip portion 240 occupies at least 180 degrees of the handle's circumference, leaving a smaller portion of said circumference for the presence of the canister replacement hatch 250. The spray activator button 225 protrudes outward from the open top chamber 245, perpendicular to the self-defense device's vertical axis, at a distance sufficient enough for optimal accessibility by the user. During regular usage, the user would depress the button in order to expel the contents of the spray device. The repellent compound would exit the open top chamber 245 at its front side, corresponding with the front of the knife blade and the grip side 240 of the handle 230.

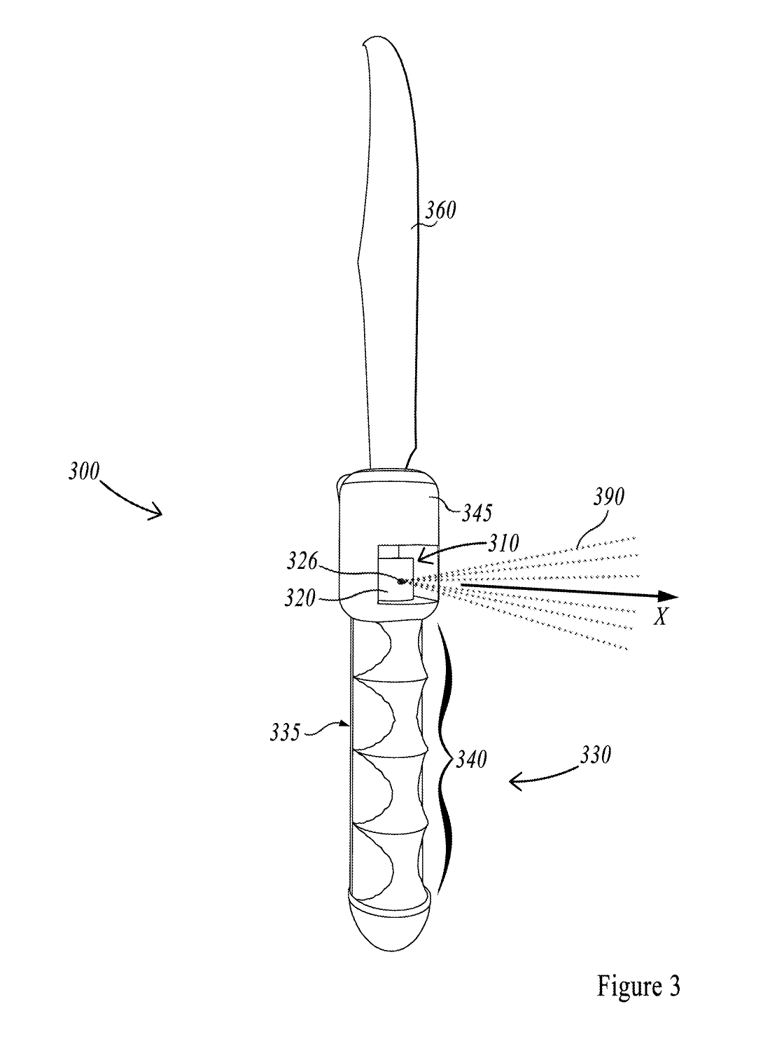

FIG. 3 illustrates a perspective view of the front side of the dual function self-defense device of the present invention, showing the grip portion of the handle, and activated spray device expelling its contents in a direction away from the knife. Directional arrow “X” indicates the movement of the repellant compound 390 out of the spray nozzle 326 and away from the front side of the self-defense device 300. By way of example, a right-handed user's thumb would enter the open top chamber 345 to depress the spray activator button, while his/her palm and remaining fingers are gripping the back and front sides of the device handle 330 respectively. With this operation completed, the user may then utilize the knife blade if necessary—without having to rotate/reorient the self-defense device 300 in any way, as both the spray nozzle 326 and cutting edge of the blade 360 exist on the front side of the device 300. Rather, a user switching from the use of the spray to the knife would at most merely remove their thumb from the activator button and onto the back side of the handle 330 (corresponding to the surface of the canister hatch as more fully shown in FIGS. 1 and 2).

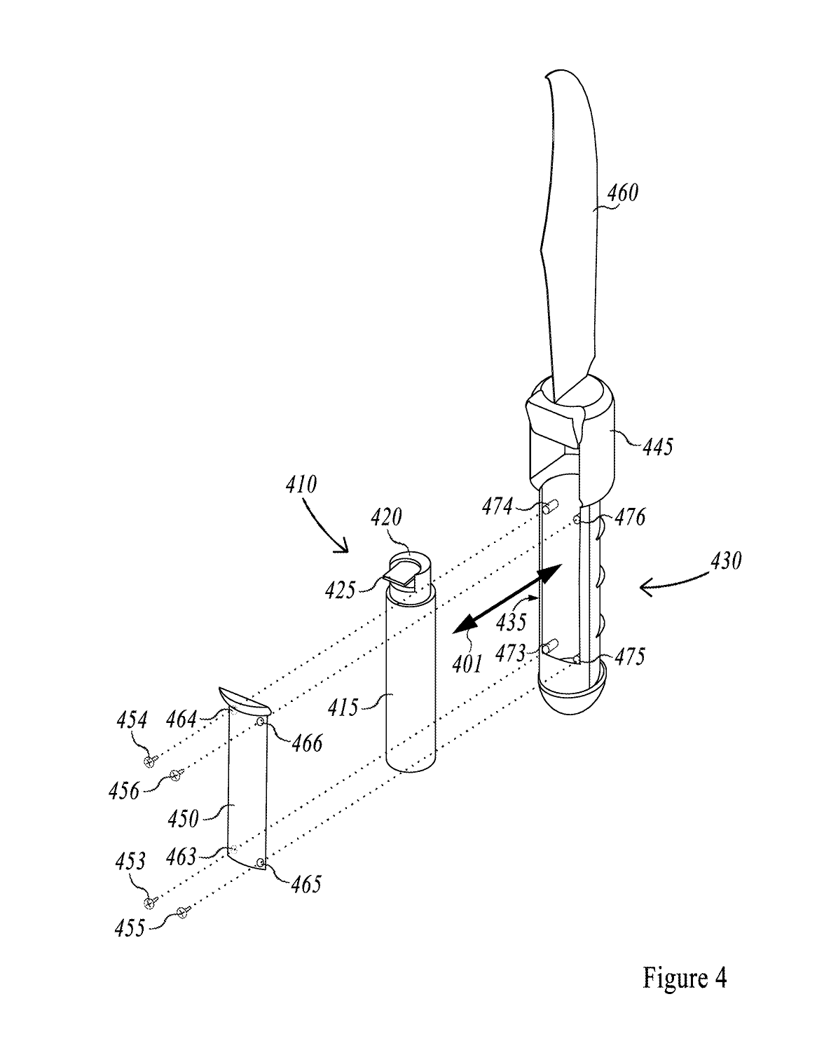

FIG. 4 illustrates an isometric view of the back side of the dual function self-defense device of the present invention, wherein the canister replacement hatch has been removed, exposing the interior chamber to facilitate spray device replacement. Screws 453-456 have been removed from threaded receptacles 473-476, which are permanently affixed to the interior surface of the lower handle chamber 435 using a method known in the art. Fastening means that do not require screws can also be used. Aligned with the threaded receptacles, pass-through holes 463-466 are found on the body of the canister hatch 450, providing entrances for the screws on the exterior of the handle 430. With the hatch removed, a user may remove the spray device 410 from the lower handle chamber 435 and replace it with a new one. This dual action is denoted by motion arrow 401. FIG. 4 shows a spray device 410 complete with spray head 420, activator button 425, and pressurized canister 415. Alternatively, the self-defense device housing can hold a dedicated canister that can be refilled with a desired chemical agent. In this scenario, the spray head (with activator button/nozzle) would be permanently integrated into the open top chamber 445.

While there have been described herein what are considered to be preferred and exemplary embodiments of the present invention, other modifications of the invention shall be apparent to those skilled in the art from the teachings herein. For example, the relative dimensions of the device may be altered while keeping within the spirit and teachings of the invention. It is therefore desired to be secured, in the appended claims all such modifications as fall within the spirit and scope of the invention.

What is claimed is:

1. A dual function self-defense device comprising:
a spray device having a pressurized, canister portion that contains chemical agents and a head portion, said head portion comprising a spray activation button and a spray nozzle for expelling the chemical agents;
a hollow handle having a hatch for accessing a handle chamber, said handle chamber configured to receive the spray device and house the pressurized canister portion of the spray device;
a spray head chamber affixed to a top side of the handle, said spray bead chamber configured to house the head portion of the spray device, and having an opening that allows access thereto; and
a knife blade affixed to a top surface of the spray head chamber.

2. The device of claim 1 wherein the pressurized canister can be removed and thus replaced by opening the handle hatch, pulling out the spray canister, and inserting a new spray canister.

3. The device of claim 1 wherein the spray canister is irreversibly connected to the spray head portion and the pressurized canister are a single unit.

4. The device of claim 1 wherein the chemical agent is a lachrymatory agent such as pepper spray.

5. The device of claim 1 wherein a portion of the handle is ergonomically contoured to fit a user's hand.
